(19) United States
(12) Patent Application Publication
(10) Pub. No.: US 2023/0050576 A1
(43) Pub. Date: Feb. 16, 2023

(54) AE-SIGNAL DETECTING DEVICE FOR ABRASIVE WHEEL

(71) Applicant: NORITAKE CO., LIMITED, Nagoya-shi, Aichi (JP)

(72) Inventors: Satoshi ISOGIMI, Nagoya-shi (JP); Tomomi OHASHI, Nagoya-shi (JP)

(73) Assignee: NORITAKE CO., LIMITED, Nagoya-shi, Aichi (JP)

(21) Appl. No.: 17/796,582

(22) PCT Filed: Dec. 11, 2020
(86) PCT No.: PCT/JP2020/046423

§ 371 Date: Jul. 29, 2022

(30) Foreign Application Priority Data
Jan. 29, 2020 (JP) 2020-012643

(51) Int. Cl. B24B 49/00; G01N 29/14

(52) U.S. Cl. CPC B24B 49/003; G01N 29/14

(57) ABSTRACT

An AE-signal detecting device for an abrasive wheel includes: an AE sensor which outputs an AE signal upon receipt of an elastic wave generated in an annular abrasive wheel sandwiched between a fixed flange fixed to a rotating shaft and a movable flange provided capable of getting closer to/separating from the fixed flange; a transmission circuit portion which wirelessly transmits the AE signal output from the AE sensor; and a reception circuit portion which receives the AE signal transmitted wirelessly, wherein the AE sensor is disposed on the movable flange or the fixed flange, detects the elastic wave transmitted from the abrasive wheel, and outputs the AE signal.

### TECHNICAL FIELD

The present invention relates to an AE-signal detecting device for a grinding wheel which outputs an AE signal by detecting an elastic wave generated from a grinding work point of the abrasive wheel.

### BACKGROUND ART

In order to determine or monitor a grinding surface state or a dressing state of a grinding wheel such as a burn mark, clogging, a cutting quality of an abrasive wheel, an abrasive-wheel peripheral surface state and the like, an AE-signal detecting device for a grinding wheel which detects a sound wave emitted form a grinding surface in relation with crushing of abrasive grains constituting the grinding wheel and outputs an AE signal (Acoustic emission signal: an oscillating wave with a relatively high frequency or in an ultrasonic region at 100 kHz or more, for example) is known. An AE-signal detecting device for a grinding wheel described in Patent Literature 1, for example, is the one.

In the AE-signal detecting device for a grinding wheel described in Patent Literature 1, in a wheel core (base metal) in which a segment grinding stone constituting a grinding layer made of a superabrasive grain layer, for example, is attached to an outer peripheral surface of an outer peripheral wall, an AE sensor which detects an elastic wave is fixed to an inner peripheral surface of the outer peripheral wall in order to detect the elastic wave in the vicinity of a grinding work point of the grinding wheel. This Patent Literature 1 describes that, by providing a grinding-wheelside AE sensor provided in the wheel core in order to output an AE signal by detecting the elastic wave generated in a vitrified grinding wheel, a workpiece-side AE sensor for detecting a workpiece-side AE signal generated in a workpiece, a frequency analyzing portion which performs frequency analysis of the grinding-wheel side AE signal and the workpiece-side AE signal, and a grinding-surface state determining portion which determines a grinding surface state of the vitrified grinding wheel on the basis of the grinding-wheel side AE signal and the workpiece-side AE signal subjected to the frequency analysis by the frequency analyzing portion, respectively, determination or evaluation of the grinding surface state of the grinding wheel is made.

### CITATION LIST

### Patent Literature

[PTL 1]

Japanese Patent Application Publication No. 2000-233369

### SUMMARY OF INVENTION

### Technical Problem

However, with the aforementioned conventional AE-signal detecting device for a grinding wheel, at replacement of the grinding-stone wheel, a grinding wheel layer attached to the outer peripheral surface of the outer peripheral wall in the wheel core or the segment grinding stone, for example, needs to be replaced, and in order to continuously operate a grinding work device, a grinding-stone wheel incorporating an AE sensor needed to be prepared as a spare. In this case, if a combination of the AE sensor and a preamplifier for amplifying the AE signal output from the AE sensor is different, absolute values of the obtained AE signals do not necessarily become the same and thus, a threshold value set for determining clogging, a cutting quality, a grinding surface state, a dressing state and the like is needed to be set again at each replacement of the grinding wheel. Moreover, since the AE sensor, the preamplifier, a communication circuit board, and a power source need to be provided in the wheel core, it cannot be applied easily to ordinary grinding stones such as a vitrified grinding stone, a resinoid grinding stone or the like, for example, that is, an abrasive wheel which is integrally molded annularly and does not have a wheel core.

The present invention was made in view of the aforementioned circumstances and has an object to provide an AE-signal detecting device for an abrasive wheel, which can detect an elastic wave from a grinding work point of an abrasive wheel, and at replacement of the abrasive wheel, does not need to have an AE sensor, a preamplifier, or a communication circuit board replaced, and can be applied also to an abrasive wheel not having a wheel core and is integrally molded.

### Solution to Problem

The inventors have, as the result of various examinations with the aforementioned circumstances as a background, found that, by incorporating at least an AE sensor in a member to which the integrally molded abrasive wheel is attached, the elastic wave from the grinding work point of the abrasive wheel can be detected, and at the replacement of the abrasive wheel, there is no need to replace the AE sensor and the communication circuit board or the like connected thereto, and even for the abrasive wheel not having a wheel core such as the vitrified grinding stone or the resinoid grinding stone, the threshold values set for determination of clogging, the cutting quality, the grinding surface state, the dressing state and the like do not have to be set again at each replacement. The present invention was made on the basis of such findings.

That is, a purpose of a first invention is (a) an AE-signal detecting device for an abrasive wheel including an AE sensor which outputs an AE signal upon receipt of an elastic wave generated in an annular abrasive wheel sandwiched between (put between) a fixed flange fixed to a rotating shaft and a movable flange provided configured to move toward and away from the fixed flange, a transmission circuit portion which wirelessly transmits the AE signal output from the AE sensor, and a reception circuit portion which receives the AE signal transmitted wirelessly, and (b) the AE sensor is disposed on the movable flange or the fixed flange, detects the elastic wave transmitted from the abrasive wheel, and outputs the AE signal.

A purpose of a second invention is, in the first invention, the movable flange or the fixed flange has an accommodating space which includes an annular outer peripheral wall and a bottom wall closing one end of the outer peripheral wall and brought into close contact with the abrasive wheel and is open to aside opposite to the abrasive wheel and the AE sensor is fixed to an inner peripheral surface of the outer peripheral wall in the accommodating space and detects the elastic wave transmitted from the abrasive wheel to the outer peripheral wall.

A purpose of a third invention is, in the first invention, the movable flange or the fixed flange has an accommodating space which includes an annular outer peripheral wall and a bottom wall closing one end of the outer peripheral wall and brought into close contact with the abrasive wheel and is open to aside opposite to the abrasive wheel is formed, and the AE sensor is fixed to the bottom wall in the accommodating space and detects the elastic wave transmitted from the abrasive wheel.

A purpose of a fourth invention is, in the third invention, the AE sensor has a reception plate and is fixed to the bottom wall in a state where the reception plate is in direct close contact with the abrasive wheel.

A purpose of a fifth invention is, in any one of the second invention to the fourth invention, a constant-voltage power-supply circuit portion which supplies a constant voltage to the transmission circuit portion wherein, and the transmission circuit portion and the constant-voltage power-supply circuit portion are provided in the accommodating space.

A purpose of a sixth invention is, in any one of the second invention to the fourth invention, a constant-voltage power-supply circuit portion which supplies a constant voltage to the transmission circuit portion wherein, the constant-voltage power-supply circuit portion receives power supply through a non-contact power-feeding device including a power-feed coil with fixed position and a power-receiving coil rotating with the rotating shaft, which are magnetically coupled with each other.

A purpose of a seventh invention is, in the fifth invention, an opening of the accommodating space is closed by a lid plate constituted at least partially by a non-conductive material.

A purpose of an eighth invention is, in any one of the first invention to the seventh invention, the abrasive wheel contains abrasive grains and a binding material which binds the abrasive grains and is integrally molded annularly.

### Advantageous Effects of Invention

According to the AE-signal detecting device for the abrasive wheel of the first invention, the AE sensor is disposed on the movable flange or the fixed flange and detects the elastic wave transmitted from the abrasive wheel, and outputs the AE signal. As a result, the fixed flange fixed to the rotating shaft and the movable flange move toward and away from each other, and the abrasive wheel can be detachably attached and thus, at replacement of the abrasive wheel, there is no need to replace the AE sensor or the circuit board, and it can be applied also to the integrally molded abrasive wheel not having a wheel core.

According to the AE-signal detecting device for the abrasive wheel of the second invention, the AE sensor is fixed to the inner peripheral surface of the outer peripheral wall in the accommodating space and detects the elastic wave transmitted from the abrasive wheel to the outer peripheral wall. As a result, since a distance from the grinding work point of the abrasive wheel is short, the elastic wave generated at the grinding work point of the abrasive wheel can be clearly detected.

According to the AE-signal detecting device for the abrasive wheel of the third invention, the movable flange or the fixed flange has the annular outer peripheral wall and the bottom wall closing one end of the peripheral wall and brought into close contact with the abrasive wheel, and the accommodating space open to the side opposite to the abrasive wheel is formed, and the AE sensor is fixed to the bottom wall in the accommodating space and detects the elastic wave transmitted from the abrasive wheel. As a result, the elastic wave generated at the grinding work point of the abrasive wheel can be clearly detected.

According to the AE-signal detecting device for the abrasive wheel of the fourth invention, the AE sensor has the reception plate, and the reception plate is fixed to the bottom wall in the state of direct close contact with the abrasive wheel. As a result, the elastic wave generated at the grinding work point of the abrasive wheel can be clearly detected.

According to the AE-signal detecting device for the abrasive wheel of the fifth invention, the constant-voltage power-supply circuit portion which supplies the constant voltage to the transmission circuit portion is provided, and the transmission circuit portion and the constant-voltage power-supply circuit portion are provided in the accommodating space. As a result, in a state of rotating together with the abrasive wheel, the radio wave can be transmitted from the transmission circuit portion provided in the accommodating space to outside the movable flange or the fixed flange.

According to the AE-signal detecting device for the abrasive wheel of the sixth invention, the constant-voltage power-supply circuit portion which supplies the constant voltage to the transmission circuit portion is provided, and the constant-voltage power-supply circuit portion receives power supply through the non-contact power-feeding device including the power-feed coil with fixed position and the power-receiving coil rotating with the rotating shaft, which are magnetically coupled with each other. As a result, a battery does not have to be mounted in the accommodating space anymore.

According to the AE-signal detecting device for the abrasive wheel of the seventh invention, the opening of the accommodating space is closed by the lid plate constituted at least partially by the non-conductive material. As a result, since the radio wave transmitted from the transmission circuit portion provided in the accommodating space to outside the movable flange or the fixed flange is not interfered, data carried by the radio wave can be received stably.

According to the AE-signal detecting device for the abrasive wheel of the eighth invention, the abrasive wheel contains abrasive grains and a binding material which binds the abrasive grains and is integrally molded annularly. As a result, the elastic wave generated at the grinding work point of ordinary grinding stones such as a vitrified grinding stone, a resinoid grinding stone or the like, that is, the abrasive wheel which is integrally molded annularly and does not have a wheel core, can be detected as the AE signal.

### BRIEF DESCRIPTION OF DRAWINGS

FIG. 1 is a diagram for explaining a constitution of a grinding work device including an AE-signal detecting device for an abrasive wheel of an embodiment of the present invention.

FIG. 2 is a partially cutaway diagram for explaining the constitution of the AE-signal detecting device for the abrasive wheel in FIG. 1 provided in a movable flange in close contact with the abrasive wheel.

FIG. 3 is a diagram illustrating a constitution of the AE-signal detecting device for the abrasive wheel in FIG. 2 in an enlarged manner.

FIG. 4 is a diagram illustrating a frequency spectrum obtained by frequency analysis of the AE signal obtained by the AE-signal detecting device shown in FIG. 2 when dressing is performed for the abrasive wheel.

FIG. 5 is a diagram illustrating a frequency spectrum obtained by frequency analysis of the AE signal obtained by the AE-signal detecting device shown in FIG. 2 when a ceramic plate is ground by the abrasive wheel.

FIG. 6 is a diagram illustrating a frequency spectrum obtained by frequency analysis of the AE signal obtained by the AE-signal detecting device shown in FIG. 2 and is a diagram illustrating the frequency spectrum at non-load rotation of the abrasive wheel.

FIG. 7 are diagrams for explaining display examples of a surface-state display device in FIG. 1.

FIG. 8 is a diagram for explaining another display example of the surface-state display device in FIG. 1.

FIG. 9 are diagrams illustrating a frequency spectrum of the AE signal obtained when the AE sensor incorporated in a base metal of a CBN vitrified grinding stone is used with a cutting speed at 0.8 mm/min and a peripheral speed at 2700 m/min on an upper stage, and a frequency spectrum of the AE signal obtained when the AE sensor incorporated in a movable flange shown in FIG. 3 sandwiching the CBN vitrified grinding stone is used on a lower stage in comparison.

FIG. 10 are diagrams illustrating a frequency spectrum of the AE signal obtained when the AE sensor incorporated in a base metal of the CBN grinding stone is used with a cutting speed at 0.8 mm/min and a peripheral speed at 2100 m/min on an upper stage, and a frequency spectrum of the AE signal obtained when the AE sensor incorporated in a movable flange shown in FIG. 3 sandwiching the CBN vitrified grinding stone is used on a lower stage in comparison.

FIG. 11 are diagrams illustrating a frequency spectrum of the AE signal obtained when the AE sensor incorporated in a base metal of the CBN vitrified grinding stone is used with a cutting speed at 2.8 mm/min and a peripheral speed at 2700 m/min on an upper stage, and a frequency spectrum of the AE signal obtained when the AE sensor incorporated in a movable flange shown in FIG. 3 sandwiching the CBN vitrified grinding stone is used on a lower stage in comparison.

FIG. 12 is a diagram illustrating an oscillation strength ratio in a case where the AE sensor is incorporated in the base metal of the CBN vitrified grinding stone and a case of being incorporated in the movable flange shown in FIG. 3 obtained under a grinding condition in FIG. 9, the grinding condition in FIG. 10, and the grinding condition in FIG. 11, respectively, in comparison.

FIG. 13 is a diagram illustrating a frequency spectrum obtained by frequency analysis of the AE signal detected by using the AE sensor incorporated in the movable flange shown in FIG. 3 sandwiching the vitrified grinding stone when the vitrified grinding stone is subjected to dressing.

FIG. 14 is a diagram illustrating a temporal change of an integral signal of the frequency spectrum obtained for each FFT analysis period in a section of 25 to 45 kHz in the frequency spectrum in FIG. 13 by a one-dot chain line, and a temporal change of the integral signal of the frequency spectrum obtained for each FFT analysis period in a section of 45 to 75 kHz in the frequency spectrum in FIG. 13 by a solid line, respectively.

FIG. 15 is a diagram illustrating the frequency spectrum of the AE signal obtained when the AE sensor incorporated in the movable flange shown in FIG. 3 sandwiching the vitrified grinding stone is used with the cutting speed at 0.8 mm/min is used.

FIG. 16 is a diagram illustrating the frequency spectrum of the AE signal obtained when the AE sensor incorporated in the movable flange shown in FIG. 3 sandwiching the vitrified grinding stone is used with the cutting speed at 2.0 mm/min.

FIG. 17 is a diagram illustrating an essential part of the AE-signal detecting device for the abrasive wheel in another embodiment of the present invention and corresponding to FIG. 3.

FIG. 18 is a diagram illustrating a frequency spectrum of the AE signal obtained when the AE sensor incorporated in the base metal of the CBN vitrified grinding stone is used with the cutting speed at 0.8 mm/min and a peripheral speed at 1500 m/min.

FIG. 19 is a diagram illustrating a frequency spectrum of the AE signal obtained when the AE sensor fixed to the bottom wall of the movable flange shown in FIG. 17 sandwiching the CBN vitrified grinding stone is used under the grinding condition similar to that of FIG. 18.

FIG. 20 is a diagram illustrating an essential part of the AE-signal detecting device for the abrasive wheel in still another embodiment of the present invention and corresponding to FIG. 3.

FIG. 21 is a diagram illustrating an essential part of the AE-signal detecting device for the abrasive wheel in still another embodiment of the present invention and corresponding to FIG. 2.

FIG. 22 is a diagram illustrating an essential part of the AE-signal detecting device for the abrasive wheel in still another embodiment of the present invention and corresponding to FIG. 3.

### DESCRIPTION OF EMBODIMENTS

Hereinafter, an embodiment of the present invention will be described in detail by referring to the drawings. Note that, in the following embodiment, the figures are to explain essential parts related to the invention, and dimensions, shapes and the like are not necessarily depicted accurately.

### Embodiment 1

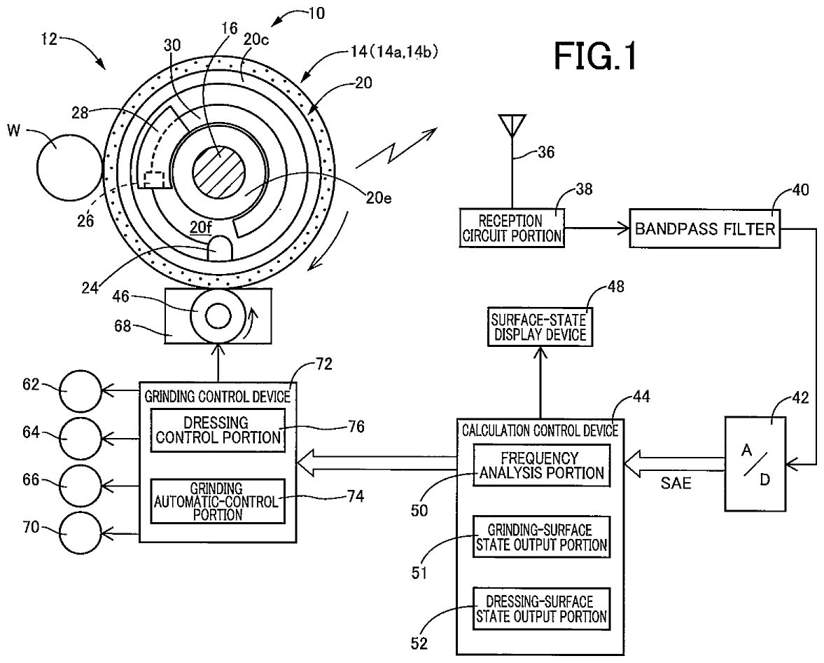

FIG. 1 is a diagram for explaining a constitution of a grinding work device 12 including a movable flange 20 functioning as a detection portion of an AE-signal detecting device 10 for an abrasive wheel 14. In FIG. 1, for the grinding work device 12, ordinary grinding stones in which abrasive grains 14a such as ordinary abrasive grains including fused alumina-based abrasive grains, silicon carbide-based abrasive grains, ceramics abrasive grains and the like and superabrasive grains such as CBN abrasive grains, diamond abrasive grains are bound by a binding material 14b such as a vitrified bond, a metal bond or the like, and which are integrally molded without a base metal (wheel core), for example, are used as an annular abrasive wheel 14.

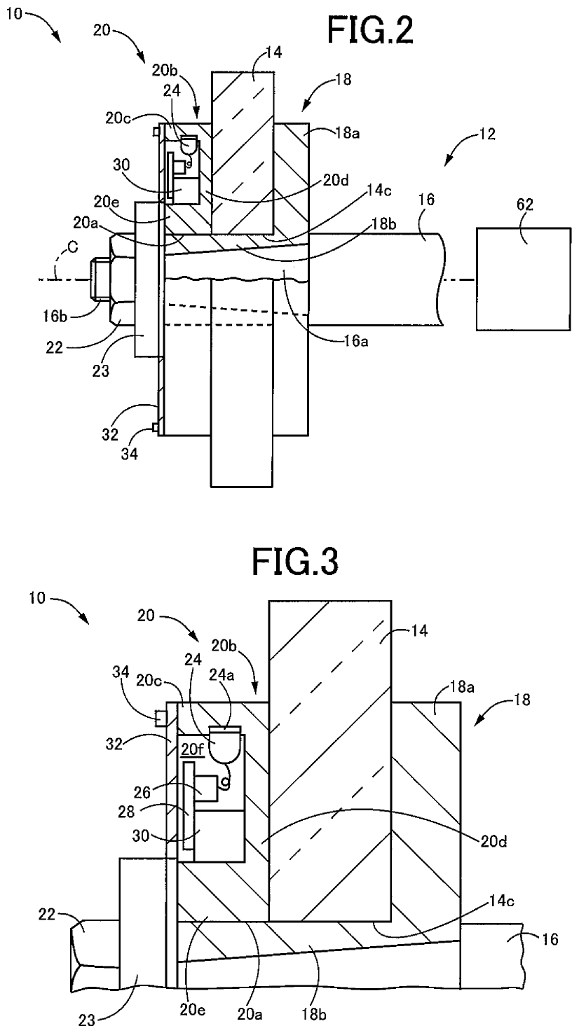

FIG. 2 illustrates an attaching structure of the abrasive wheel 14. On a shaft end of a rotating shaft (spindle) 16 of the grinding work device 12 rotationally driven around a rotation center line C, a male thread 16b is formed. The abrasive wheel 14 is attached in a state clamped between a fixed flange 18 and a movable flange 20 which are made of iron and attached to the shaft end of the rotating shaft 16 by being fastened by a nut 22 screwed with the male thread 16b of the rotating shaft 16. The fixed flange 18 includes a cylinder portion 18b tapered/fitted with a tapered portion 16a formed on a shaft end part of the rotating shaft 16 and a fixed flange portion 18a, which is a disc part protruding in a radial direction (outer peripheral side) from one end of the cylinder portion 18b.

The movable flange 20 includes a through hole 20a slidably fitted in the cylinder portion 18b concentrically with the rotation center line C and a movable flange portion 20b, which is a disc part in close contact with the abrasive wheel 14. When the nut 22 is screwed with the shaft end of the rotating shaft 16, the movable flange 20 is pressed through a washer 23, whereby the abrasive wheel 14 is fixed in a state clamped between the fixed flange portion 18a and the movable flange portion 20b. The abrasive wheel 14 grinds an outer peripheral surface of a columnar workpiece W as shown in FIG. 1, for example.

FIG. 3 is a diagram illustrating a constitution of the detection portion of the AE-signal detecting device 10 for the abrasive wheel 14 in an enlarged manner. The movable flange portion 20b integrally has a cylindrical outer peripheral wall 20c, a bottom wall 20d closing one end of the outer peripheral wall 20c and brought into close contact with the abrasive wheel 14, and a cylindrical inner peripheral wall 20e concentrical with the outer peripheral wall 20c, and an annular accommodating space 20f open to a side opposite to the abrasive wheel 14 is formed inside. The AE sensor 24 is fixed to the inner peripheral surface of the outer peripheral wall 20c in the accommodating space 20f and detects an elastic wave transmitted from a grinding point of the abrasive wheel 14 to the outer peripheral wall 20c.

In the accommodating space 20f, a preamplifier 26 which amplifies an output signal of the AE sensor 24, a transmission circuit portion 28 constituted by a circuit board including an antenna and a transmission circuit and transmitting an output signal from the preamplifier 26 to the air, and a battery 30 which supplies a constant voltage to the transmission circuit portion 28 which AD-converts the output signal from the preamplifier 26 and transmits it to the air are fixed/provided. The battery 30 is a secondary battery which functions as a constant-voltage power-supply circuit portion and supplies power to the preamplifier 26 and the transmission circuit portion 28. A lid plate 32 is constituted by a material transmitting a radio wave, that is, a non-conductive material such as a synthetic resin plate, a glass plate or the like, for example, and is fixed to the movable flange 20 by a lock screw 34 in a state closing the opening of the accommodating space 20f. The transmission circuit portion 28 is preferably constituted by a communication module including an MCU performing Wi-fi communication of IEEE802.11ac standard, for example.

The AE sensor 24 detects crushing vibration (acoustic emission) with an extremely high frequency, which is an elastic vibration range of an ultrasonic area of 20 kHz or more, for example, which is generated at crushing of the abrasive grains 14a or the like contained in the abrasive wheel 14 and transmitted in the abrasive wheel 14 through the bottom wall 20d in close contact with the abrasive wheel 14 and outputs an AE signal SAE, which is an analog electric signal indicating the crushing vibration. The AE sensor 24 has a reception plate 24a which detects the elastic wave on one end part and includes a mechanical/electric conversion element such as a piezoelectric element, for example, which converts mechanical vibration received by the reception plate 24a to the AE signal SAE and outputs it.

Returning to FIG. 1, the grinding work device 12 further includes a reception circuit portion 38 having an antenna 36 for receiving the AE signal SAE transmitted wirelessly from the transmission circuit portion 28, a bandpass filter 40 including a predetermined frequency band through which a carrier wave received by the reception circuit portion 38 passes, an A/D converter 42 which A/D converts the AE signal SAE demodulated from the carrier wave, and a calculation control device 44 which processes the AE signal SAE converted to the digital signal.

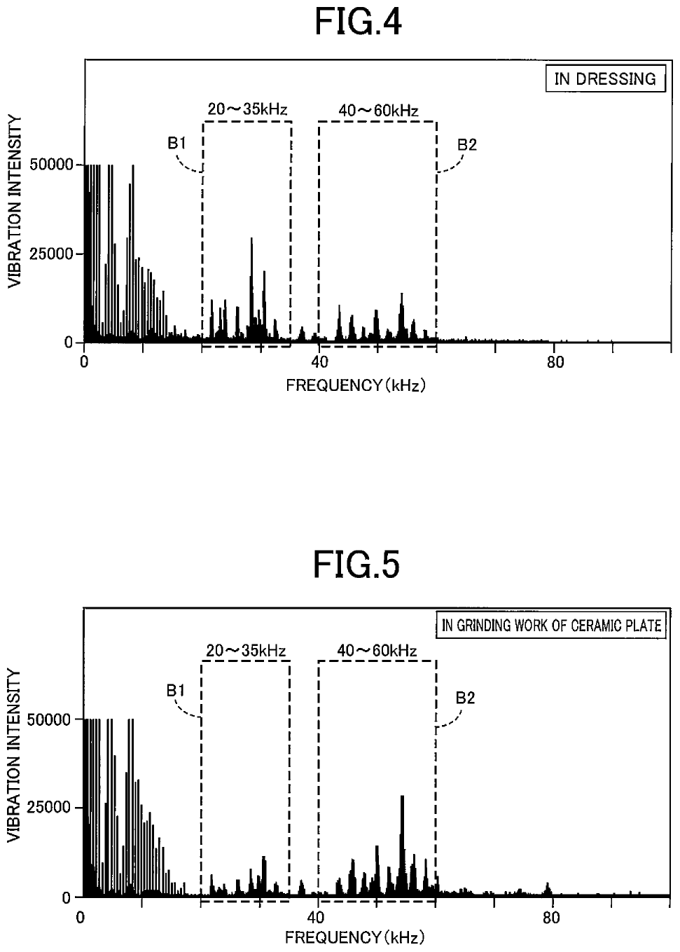

The A/D converter 42 has a high-resolution performance and converts the AE signal SAE to a digital signal in a sampling period of 10 μseconds (micro seconds) or less, for example, preferably a sampling period of 5 μseconds or less, or more preferably a sampling period of 1 μsecond or less. The shorter (the faster) the sampling period of the A/D converter 42 is, the clearer a first frequency band B1 related to shedding (abrasive-grain crushing) and a second frequency band B2 related to frictional vibration or elastic vibration generated by contact (friction) between the abrasive grain and the workpiece become as shown in FIG. 4 and FIG. 5 explained later, for example, become. Note that, in the following embodiment, 1 μsecond is used for the sampling period of the A/D converter 42.

The calculation control device 44 is an electronic control device, that is, a so-called microcomputer including a CPU, a ROM, a RAM, an interface and the like, and the CPU processes an input signal in accordance with a program stored in the ROM in advance while using a temporary storage function of the RAM so as to calculate a numeral value, a graph, a figure or the like indicating the grinding surface state for determining a dressing surface state, and outputs it from a surface-state display device 48 also functioning as a grinding-surface state display device and transmits it to the grinding control device 72.

The calculation control device 44 of the grinding work device 12 functionally includes a frequency analysis portion 50, a grinding-surface state output portion 51, and a dressing-surface state output portion 52. The frequency analysis portion 50 repeatedly executes frequency analysis (FFT) of the AE signal SAE input from the A/D converter 42 during grinding of the workpiece W or dressing of the abrasive wheel 14 and generates a frequency spectrum showing various signal intensities indicating sizes of a frequency component on a frequency axis (lateral axis) with a peak waveform for each frequency in a two-dimensional coordinate of a vertical axis indicating a signal intensity and the lateral axis indicating a frequency.

The grinding-surface state output portion 51 calculates a first signal intensity SP1 for the first frequency band B1 set in advance including 32.5 kHz, for example, in a center part or the first frequency band B1 from 20 to 35 kHz, for example, and a second signal intensity SP2 for the second frequency band B2 set in advance including 55 kHz, for example, in the center part or the second frequency band B2 from 40 to 60 kHz, for example, respectively, during the grinding work of the workpiece W from the frequency spectrum. As the first signal intensity SP1 and the second signal intensity SP2, they may be instantaneous values but in order to stably grasp dulling and shedding, it is preferable that integral values or moving average deviations in a predetermined period set sufficiently longer than a sampling period of the A/D converter 42, specifically in a frequency analysis period are used, for example.

Moreover, the dressing-surface state output portion 52 calculates, similarly to the grinding-surface state output portion 51, during the dressing of the abrasive wheel 14 using a dresser 46, the first signal intensity SP1 for the first frequency band B1 set in advance including 32.5 kHz in the center part or the first frequency band B1 of 25 to 35 kHz, for example, and the second signal intensity SP2 for the second frequency band B2 set in advance including 55 kHz in the center part or the second frequency band B2 from 40 to 60 kHz, for example, respectively, from the aforementioned frequency spectrums. As the first signal intensity SP1 and the second signal intensity SP2, they may be instantaneous values but in order to stably grasp dulling and shedding, it is preferable that integral values or moving average deviations in a predetermined period set sufficiently longer than a sampling period of the A/D converter 42 or in a frequency analysis period are used, for example.

The grinding-surface state output portion 51 during the grinding of the workpiece W or the dressing-surface state output portion 52, during the dressing of the abrasive wheel 14, calculates a dressing-surface state evaluation value or a related value (a level value, for example) related to the integral value or the moving average deviation in the predetermined period of the signal intensity, for example, or a signal intensity ratio SR (=SP1/SP2) or its related value (a level value, for example) on the basis of at least either of the first signal intensity SP1 and the second signal intensity SP2, respectively, and outputs them to the surface-state display device 48.

As a result, at least either one of the first signal intensity SP1 and the second signal intensity SP2, as shown in the frequency spectrums in FIG. 4 and FIG. 5 the signal intensity ratio SR or their related values are displayed on the surface-state display device 48 as the grinding-surface state evaluation value or the dressing-surface state evaluation value. Note that, when one of the first signal intensity SP1 and the second signal intensity SP2 is used, the grinding-surface state evaluation value or the dressing-surface state evaluation value may be either one signal intensity value itself of the first signal intensity SP1 and the second signal intensity SP2 or may be a value converted to an index value that can be grasped easily such as the level value, for example.

Regarding generation of a peak waveform signal group in the first frequency band B1 and a peak waveform signal group in the second frequency band B2, in the frequency spectrum obtained by the frequency analysis of the SAE signal converted to a digital signal by using the high-speed and high-resolution A/D converter 42 from the AE signal wave detected by the AE sensor 24, with grinding tests conducted by the inventor for the CBN resinoid abrasive wheel will be described below.

A grinding test 1 is a verification test of generation of the first frequency band B1 and the second frequency band B2 constituted by the peak-waveform signal groups in the frequency spectrum obtained in dressing, grinding work of a ceramic plate, and non-load rotation, respectively, for the CBN resinoid grinding stone. A grinding test 2 is a verification test of generation of the first frequency band B1 and the second frequency band B2 constituted by the peak-waveform signal groups in the frequency spectrum obtained in the grinding and dressing of the vitrified grinding stone.

(Grinding Test 1)

In order to confirm generation of the first frequency band B1 and the second frequency band B2, dressing and grinding were performed under the following conditions. Regarding the following grinding tool, as shown in FIG. 2 and FIG. 3, the movable flange 20 incorporating the AE sensor 24 was attached in close contact to a side surface of the CBN resinoid grinding stone.

Grinding tool: CBN resinoid grinding stone CBC 170 P 75 B
Diameter 400 mm×thickness 10 mm

Dressing tool: Rotary dresser SD 40 Q M
Diameter 100 mm×width 1.5 mm

Ceramic plate: Alumina plate with a thickness of 1 mm

Peripheral speed of grinding tool: 1250 m/min

Peripheral speed of dresser: 864 m/min

Cutting amount of dresser: diameter 0.002 mm/pass

Dressing lead: 0.15 mm/r.o.w.

Cutting amount for ceramic plate: 200 μm

Cutting speed for ceramic plate: 1.2 mm/min

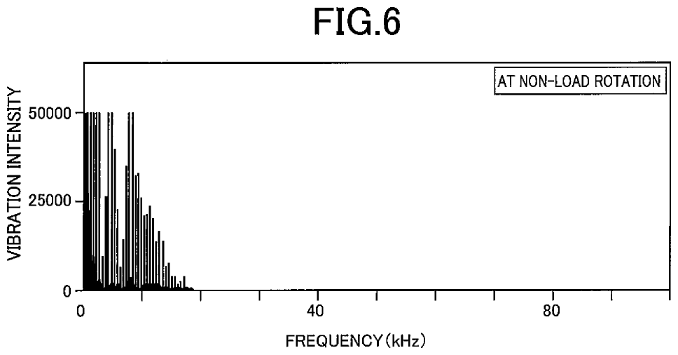

FIGS. 4, 5, and 6 show the frequency spectrums of the AE signals obtained in each of the dressing of the CBN resinoid grinding stone, the grinding of the ceramic plate, the non-load rotation, respectively. In the non-load rotation of the CBN resinoid grinding stone, as shown in FIG. 6, the frequency components in the first frequency band B1 and the second frequency band B2 are not included. However, in the dressing of the CBN resinoid grinding stone, as shown in FIG. 4, the frequency component in the first frequency band B1 of 25 to 35 Hz and the frequency component in the second frequency band B2 at 40 to 60 Hz were generated. Moreover, in the grinding work of ceramic plate with the CBN resinoid grinding stone, as shown in FIG. 5, the frequency component of the first frequency band B1 at 20 to 35 Hz and the frequency component of the second frequency band B2 at 40 to 60 Hz were generated.

Power of the frequency component in the first frequency band B1 in the grinding work of the ceramic plate in FIG. 5 is relatively small as compared with that in the dressing in FIG. 4, and it is presumed that, since the ceramic plate is a brittle material, crushing of the abrasive grains 14a in the working of the ceramic plate does not easily occur. In the dressing, since the crushing of the abrasive grains 14a is promoted, the power of the frequency component in the first frequency band B1 is relatively large, but the power of the frequency component in the second frequency band B2 is relatively small. From the above, it is presumed that the power of the frequency component in the first frequency band B1 derives from vibration generated at crushing of the abrasive grains 14a, while the power of the frequency component of the second frequency band B2 derives from frictional vibration or elastic vibration caused by contact between the abrasive grains 14a and the ceramic plate or between the abrasive grains 14a and the dresser 46.

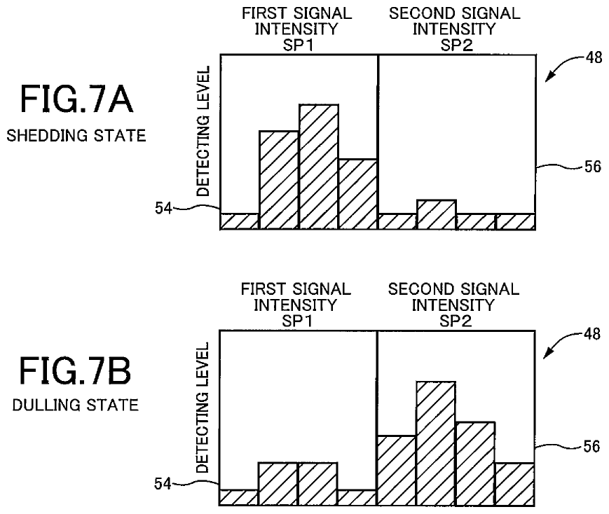

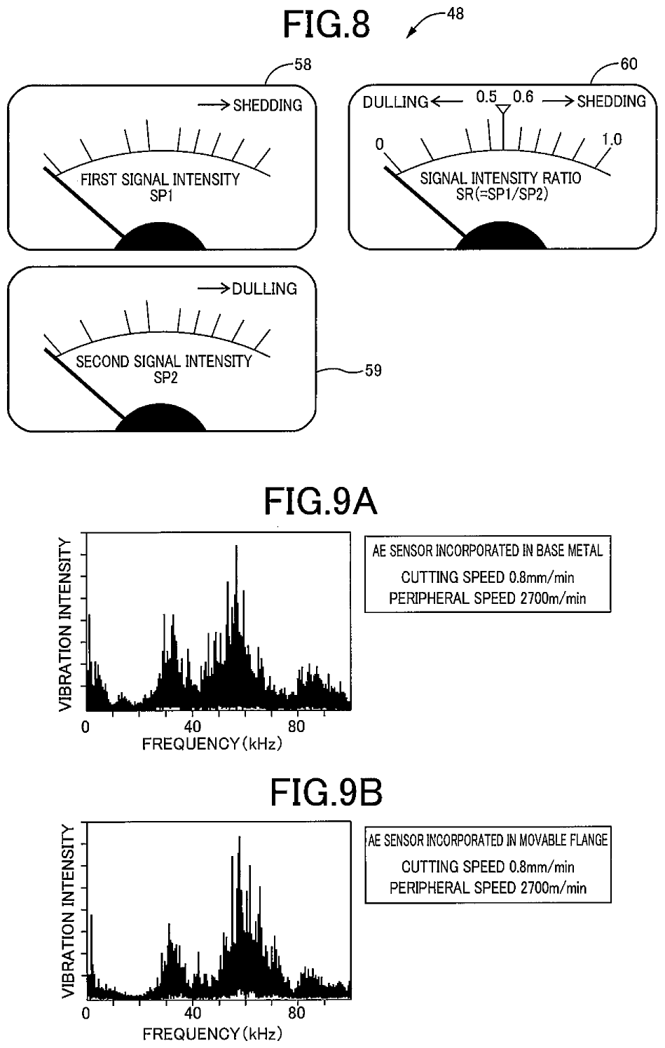

FIGS. 7(a) and 7(b) show a bar-graph type level display example displayed on a liquid crystal screen, for example, as a display mode of the surface-state display device 48 in FIG. 1, FIG. 8 shows a level-meter type display example displayed on the liquid crystal screen or an instrument, for example, as a display mode of the surface-state display device 48 in FIG. 1. In FIGS. 7(a) and 7(b), both the first signal intensity SP1 and the second signal intensity SP2 are displayed, but either one of them may be displayed as an evaluation value indicating the dressing-surface state. In FIG. 8, the first signal intensity SP1, the second signal intensity SP2, and the signal intensity ratio SR (=SP1/SP2) are displayed, but any one of them or level values corresponding thereto may be displayed as an evaluation value indicating the grinding-surface state or the dressing-surface state. The evaluation values indicating these grinding-surface state or the dressing-surface state are used in manual control in which the grinding condition or the dressing condition in the grinding work device (dressing device) 12 is to be adjusted manually.

In each of FIG. 7(a) and FIG. 7(b), a bar graph 54 showing the first signal intensity SP1 for the first frequency band B1 related to the crushing of the abrasive grains 14a is shown on the left side, while a bar graph 56 showing the second signal intensity SP2 for the second frequency band B2 related to sliding contact between the abrasive grains 14a and the dresser 46 is shown on the right side, as a pair. The shedding state can be evaluated on the basis of the crushed state of the abrasive grains 14a in the first frequency band B1 indicated by the bar graph 54 on the left side, while the dulling state can be evaluated on the basis of the sliding contact state between the abrasive grains 14a and the dresser 46 in the second frequency band B2 indicated by the bar graph 56 on the right side.

Moreover, since the bar graphs 54 and 56 in each of FIG. 7(a) and FIG. 7(b) show the signal intensity in each frequency band divided into four parts in the first frequency band B1 and the second frequency band B2, respectively, determination can be made on whether it is the shedding state or the dulling state by comparing the bar graphs 54 and 56 on the left and right, where the vibration intensity at the abrasive-grain crushing exceeds the intensity of the frictional vibration or elastic vibration caused by the contact between the abrasive grains 14a and the dresser 46 in the shedding state as shown in FIG. 7(a) and the vibration intensity at the abrasive-grain crushing falls below the intensity of the frictional vibration or elastic vibration caused by the contact between the abrasive grains 14a and the dresser 46 in the dulling state as shown in FIG. 7(b). Furthermore, on the basis of a crushing intensity pattern in each of the first frequency band B1 and the second frequency band B2, the frictional vibration or elastic vibration state caused by crushing of the abrasive grains 14a and the contact between the abrasive grains 14a and the dresser 46 can be accurately evaluated.

Display examples of the surface-state display device 48 in FIG. 8 are constituted by a plurality of meter-type displays 58, 59, 60 indicating a scale using a hand. The display 58 indicates the first signal intensity SP1 in the first frequency band B1 related to the crushing of the abrasive grains 14a, and the display 59 indicates the second signal intensity SP2 in the second frequency band B2 related to the frictional vibration or elastic vibration generated by contact between the abrasive grains 14a and the dresser 46. On the basis of the vibration intensity at the abrasive-grain crushing in the first frequency band B1 indicated by the display level on the display 58, the shedding state can be evaluated, and on the basis of the intensity of the frictional vibration or elastic vibration generated by contact between the abrasive grains 14a and the dresser 46 in the second frequency band B2 indicated by the display level on the display 59, the dulling state can be evaluated.

Moreover, on the basis of the comparison of the signal intensity in each of the first frequency band B1 and the second frequency band B2 indicated by the display levels of the displays 58 and 59, respectively, the shedding state or the dulling state can be evaluated further accurately. The display 60 shows the signal intensity ratio SR (=SP1/SP2) between the first signal intensity SP1 in the first frequency band B1 related to the crushing of the abrasive grains 14a and the second signal intensity SP2 in the second frequency band B2 related to the friction state between the abrasive grains 14a and the dresser 46.

Returning to FIG. 1, the grinding work device 12 includes a spindle drive motor 62 which rotationally drives the rotating shaft 16 on which the abrasive wheel 14 is mounted, a workpiece drive motor 64 which rotationally drives the columnar workpiece W, a workpiece moving motor 66 which moves the workpiece W in the radial direction in order to press the abrasive wheel 14 onto the outer peripheral surface of the columnar workpiece W, a dresser drive motor 68 which rotationally drives the dresser 46, a dresser feed motor 70 which feeds the dresser 46 in a direction of the rotation center line C, and a grinding control device 72.

The grinding control device 72 is constituted by a microcomputer similarly to the calculation control device 44 and functionally includes a grinding automatic-control portion 74 and a dressing control portion 76. When the grinding automatic-control portion 74 receives a grinding start-instruction signal, the grinding automatic-control portion 74 causes the workpiece W to be ground by relatively moving the abrasive wheel 14 and the workpiece W while rotationally driving the abrasive wheel 14 and the workpiece W, respectively, by an operation set in advance, and when the grinding of the workpiece W is completed, it stops the rotation of the workpiece W and returns it to an original position.

The grinding automatic-control portion 74, in a process of the grinding work of the workpiece W, automatically controls the spindle drive motor 62, the workpiece drive motor 64, and the workpiece moving motor 66 so that the grinding surface state indicated by an actual evaluation value for the workpiece W becomes the grinding surface state indicated by a target evaluation value set in advance on the basis of the actual first signal intensity SP1, second signal intensity SP2 or the signal intensity ratio SR (=SP1/SP2) output from the dressing-surface state output portion 52. For example, the grinding automatic-control portion 74 sets a target signal intensity ratio SRT to a value with a good balance of dulling and shedding and automatically adjusts the grinding condition so that the actual signal intensity ratio SR sequentially output on a real-time basis from the dressing-surface state output portion 52 matches the target signal intensity ratio SRT set in advance to approximately 0.55, for example.

For example, if the actual signal intensity ratio SR exceeds the target signal intensity ratio SRT set in advance, it means a shedding tendency and thus, in order to suppress the shedding, the actual signal intensity ratio SR is changed toward the target signal intensity ratio SRT by executing at least one of lowering of working efficiency (cutting speed), rise of a peripheral speed Vg of the abrasive wheel 14 (rise of a rotation number thereof), and lowering of the peripheral speed of the workpiece W. On the contrary, if the actual signal intensity ratio SR falls below the target signal intensity ratio SRT set in advance, it means a dulling tendency and thus, in order to suppress the dulling, the actual signal intensity ratio SR is changed toward the target signal intensity ratio SRT by executing at least one of rise of working efficiency (cutting speed), lowering of a peripheral speed Vg of the abrasive wheel 14 (lowering of a rotation number thereof), and rise of the peripheral speed of the workpiece W.

The inventors conducted an experiment for verifying consistency between a case where the AE sensor 24 is provided in the base metal and a case in which the AE sensor 24 is provided in the movable flange 20 sandwiching a vitrified CBN grinding stone not having the base metal as shown in FIG. 3 under a common point that the vitrified CBN grinding stone was used where the grinding condition described below.

<Grinding Condition>

Grinding stone: CB 80 N 200 V

Grinding machine: General-purpose cylindrical grinding machine

Grinding method: Wet plunge grinding

Grinding-stone peripheral speed: 2100 m/min, 2700 m/min

Workpiece material: SCM435 hardened steel HRc48±2

Workpiece peripheral speed: 0.45 m/sec

Cutting speed: R0.8 mm/min, R2.8 mm/min

Spark-out: 10 rev

Grinding fluid: Noritake Cool SEC700 (×50)

Grinding-fluid flowrate: 20 L/min

FIG. 9 illustrate the frequency spectrums of the AE signals obtained when the cutting speed is R0.8 mm/min and the peripheral speed is 2700 m/min, FIG. 9(a) shows the frequency spectrum of the AE signal obtained when the AE sensor 24 incorporated in the base metal of the CBN vitrified grinding stone was used and FIG. 9(b) shows the frequency spectrum of the AE signal obtained when the AE sensor 24 incorporated in the movable flange 20 sandwiching the CBN vitrified grinding stone in comparison.

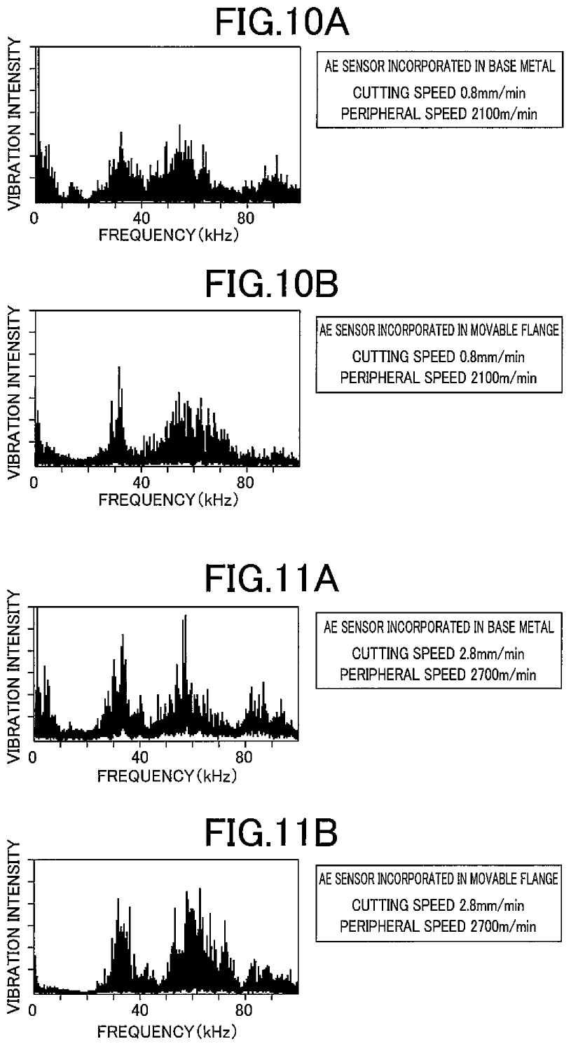

FIG. 10 illustrate the frequency spectrums of the AE signals obtained when the cutting speed is R0.8 mm/min and the peripheral speed is 2100 m/min, FIG. 10(a) shows the frequency spectrum of the AE signal obtained when the AE sensor 24 incorporated in the base metal of the CBN vitrified grinding stone was used and FIG. 10(b) shows the frequency spectrum of the AE signal obtained when the AE sensor 24 incorporated in the movable flange 20 sandwiching the CBN vitrified grinding stone in comparison.

FIG. 11 illustrate the frequency spectrums of the AE signals obtained when the cutting speed is R2.8 mm/min and the peripheral speed is 2700 m/min, FIG. 11(a) shows the frequency spectrum of the AE signal obtained when the AE sensor 24 incorporated in the base metal of the CBN vitrified grinding stone was used and FIG. 11(b) shows the frequency spectrum of the AE signal obtained when the AE sensor 24 incorporated in the movable flange 20 sandwiching the CBN vitrified grinding stone in comparison.

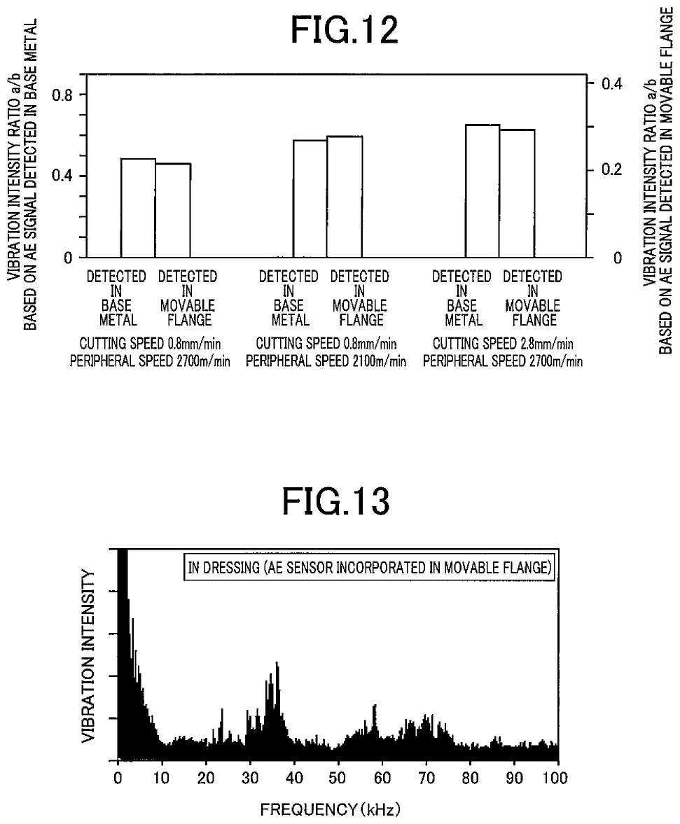

FIG. 12 illustrates a vibration intensity ratio a/b of the frequency spectrum obtained by the frequency analysis of the AE signal in the case in which the AE sensor 24 is incorporated in the base metal of the CBN vitrified grinding stone and the case of being incorporated in the movable flange 20 under the grinding condition in FIG. 9, FIG. 10, and FIG. 11, respectively, in comparison. Here, reference character a denotes the vibration intensity which is an amplitude average value in the first frequency band B1 at 28 to 36 kHz, and reference character b denotes the vibration intensity, which is an amplitude average value in the second frequency band B2 of 45 to 75 kHz.

As is obvious from FIGS. 9(a) and 9(b), 10(a) and 10(b), 11(a) and 11(b), and 12, in each of the aforementioned grinding conditions, it was confirmed that the vibration intensity and the vibration intensity ratio show similar tendencies between the case in which the AE sensor 24 is incorporated in the base metal and the case in which the AE sensor 24 is incorporated in the movable flange 20.

(Grinding Test 2)

Moreover, the inventors measured the vibration by using the AE sensor 24 incorporated in the movable flange 20 when the dressing was performed by using the dressing condition shown below in a state where the vitrified grinding stone (general grinding stone without a base metal: SH 80 J 8 V) is put between the fixed flange 18 and the movable flange 20. In this test, a resin label with a thickness of 0.5 mm is interposed between the vitrified grinding stone and each of the fixed flange 18 and the movable flange 20.

<Dressing Condition>

Dresser: LL single-stone dresser □0.8 mm

Grinding-stone peripheral speed: 2700 m/min

Dressing lead: 0.1 mm/r.o.w.

Dressing cutting amount: 20 μm/pass

Total cutting amount: R200 μm

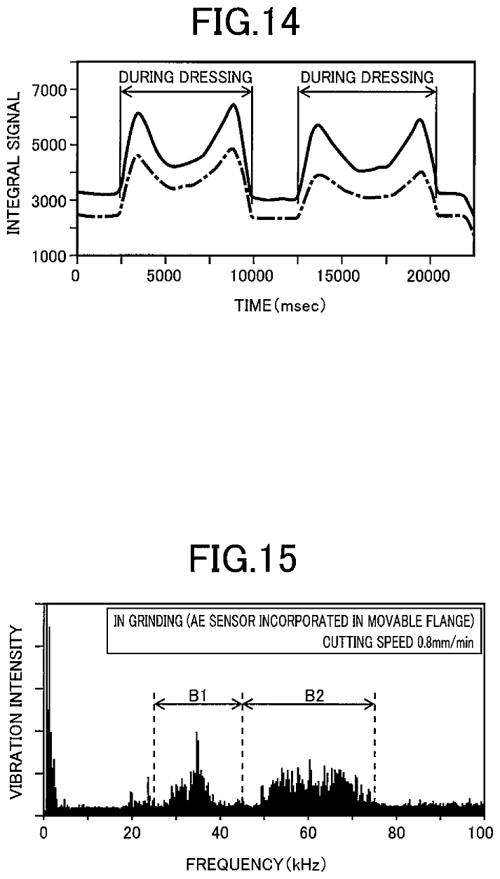

FIG. 13 illustrates a frequency spectrum obtained by frequency analysis of the AE signal detected by using the AE sensor 24 incorporated in the movable flange 20 sandwiching the vitrified grinding stone when the vitrified grinding stone is dressed. FIG. 14 illustrates temporal changes of the integral signal of the frequency spectrum obtained for each FFT analysis period, where a one-dot chain line denotes the temporal change in a section of 25 to 45 kHz in the frequency spectrum in FIG. 13, and a solid line denotes the temporal change in a section of 45 to 75 kHz in the frequency spectrum in FIG. 13, respectively.

As is obvious from FIG. 13 and FIG. 14, the AE signal generated during dressing can be clearly recognized. Note that, from a change in power consumption during the dressing, the fact that it is during the dressing was hidden by noises and could not be recognized.

Moreover, the inventors measured the vibration by using the AE sensor 24 incorporated in the movable flange 20 when the grinding was performed with the grinding condition shown below in a state where the vitrified grinding stone (general grinding stone without a base metal: SH 80 J 8 V) which was dressed by using the aforementioned dressing condition is put between the fixed flange 18 and the movable flange 20.

<Grinding Condition>

Vitrified grinding stone: SH 80 J 8 V

Grinding machine: General-purpose cylindrical grinding machine

Grinding method: Wet plunge grinding

Grinding-stone peripheral speed: 2700 m/min

Workpiece material: SCM435 hardened steel HRc48±2

Workpiece peripheral speed: 27 m/min

Workpiece material: SCM435

Cutting speed: R0.8 mm/min, R2.0 mm/min

Spark-out: 10 rev

Grinding fluid: Noritake Cool SEC700 (×50)

Grinding-fluid flowrate: 20 L/min

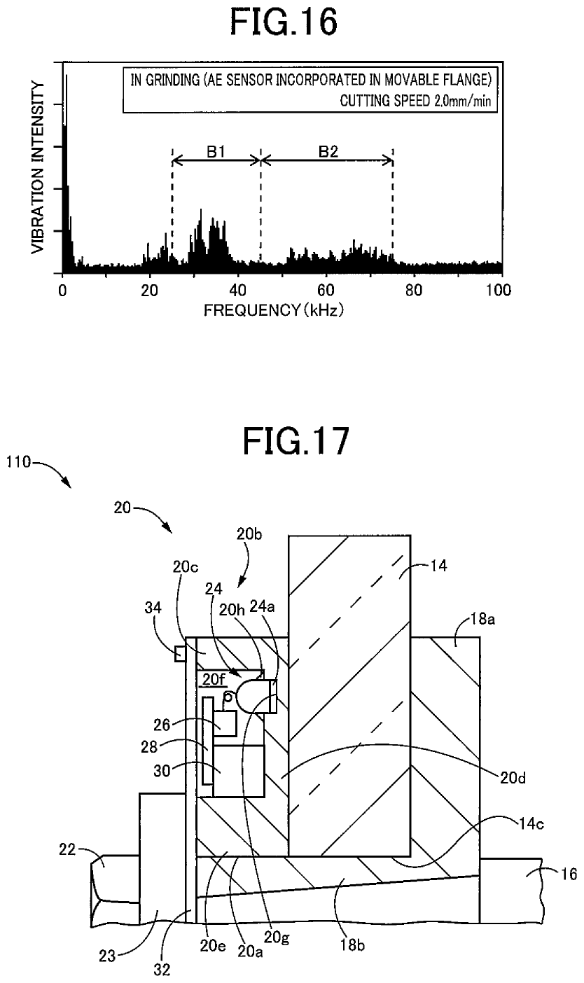

FIG. 15 illustrates a frequency spectrum of the AE signal obtained when the AE sensor 24 incorporated in the movable flange 20 sandwiching the vitrified grinding stone was used with the cutting speed at R0.8 mm/min. FIG. 16 illustrates a frequency spectrum of the AE signal obtained when the AE sensor 24 incorporated in the movable flange 20 sandwiching the vitrified grinding stone was used with the cutting speed at R2.0 mm/min.

As is shown in FIG. 15 and FIG. 16, vibration peaks generated in specific frequency bands, that is, in the first frequency band B1 of 25 to 45 kHz and in the second frequency band B2 of 45 to 75 kHz, could be detected. Moreover, as compared with the case of the cutting speed at R0.8 mm/min shown in FIG. 15, the vibration peak generated in the second frequency band B2 of 45 to 75 kH is relatively small when the cutting speed is R20 mm/min shown in FIG. 16. It is presumed to be a result that acting abrasive grains decreased due to removal of the abrasive grains 14a due to a high working load.

As described above, according to the AE-signal detecting device 10 for the abrasive wheel 14 in this embodiment, the AE-signal detecting device 10 for the abrasive wheel 14 includes the AE sensor 24 which outputs the AE signal upon receipt of the elastic wave generated in the annular abrasive wheel 14 sandwiched between the fixed flange 18 fixed to the rotating shaft 16 and the movable flange 20 provided to move toward and away from the fixed flange 18, the transmission circuit portion 28 which wirelessly transmits the AE signal output from the AE sensor 24, and the reception circuit portion 38 which receives the AE signal sent wirelessly, wherein the AE sensor 24 is disposed in the movable flange 20, detects the elastic wave transmitted from the abrasive wheel 14 through the movable flange 20, and outputs the AE signal. Since the fixed flange 18 fixed to the rotating shaft 16 and the movable flange 20 move toward and away from each other and the abrasive wheel 14 can be detachably attached, at replacement of the abrasive wheel 14, there is no need to replace the AE sensor 24 or the circuit board, and the AE signal detecting device 10 can be applied also to the integrally molded abrasive wheel not having a wheel core.

Moreover, according to the AE-signal detecting device 10 for the abrasive wheel 14 of this embodiment, the movable flange 20 has the accommodating space 20f open to the side opposite to the abrasive wheel 14 including the annular outer peripheral wall 20c and the bottom wall 20d closing one end of the outer peripheral wall 20c and brought into close contact with the abrasive wheel 14, and the AE sensor 24 is fixed to the inner peripheral surface of the outer peripheral wall 20c in the accommodating space 20f and detects the elastic wave transmitted from the abrasive wheel 14 to the outer peripheral wall 20c. Since the distance from the grinding work point of the abrasive wheel 14 can be made short, the elastic wave generated at the grinding work point of the abrasive wheel 14 can be clearly detected.

Moreover, according to the AE-signal detecting device 10 for the abrasive wheel 14 of this embodiment, the battery (constant-voltage power-supply circuit portion) 30 which supplies a constant voltage to the transmission circuit portion 28 is provided, and the transmission circuit portion 28 and the battery 30 are provided in the accommodating space 20f. The radio wave can be transmitted from the transmission circuit portion 28 provided in the accommodating space 20f to outside the movable flange 20 in a state of being rotated together with the abrasive wheel 14.

Moreover, according to the AE-signal detecting device 10 for the abrasive wheel 14 of this embodiment, the opening of the accommodating space 20f is closed by the lid plate 32 constituted at least partially by the non-conductive material such as plastic. The radio wave transmitted from the transmission circuit portion 28 provided in the accommodating space 20f to outside the movable flange 20 is not interfered but is received by the antenna 36 of the reception circuit portion 38 with fixed position further easily.

Moreover, according to the AE-signal detecting device 10 for the abrasive wheel 14 of this embodiment, the abrasive wheel 14 contains the abrasive grains 14a and the binding material 14b which binds the abrasive grains 14a and is integrally molded annularly. As a result, the elastic wave generated at a grinding point of the general grinding stone such as the vitrified grinding stone, the resinoid grinding stone and the like, that is, the annularly and integrally molded abrasive wheel not having a wheel core can be detected as the AE signal.

Moreover, according to the AE-signal detecting device 10 for the abrasive wheel 14 of this embodiment, the movable flange 20 having the annular outer peripheral wall 20c and the bottom wall 20d closing one end of the outer peripheral wall 20c and brought into close contact with the abrasive wheel 14, and the accommodating space 20f open to the side opposite to the abrasive wheel 14 formed, the AE sensor 24 fixed to the outer peripheral wall 20c in the accommodating space 20f, detecting the elastic wave generated at the grinding work point of the abrasive wheel 14, and outputting the AE signal SAE, the transmission circuit portion 28 which is provided in the accommodating space 20f and wirelessly transmits the AE signal SAE output from the AE sensor 24, and the non-conductive lid plate 32 which closes the opening of the accommodating space 20f are provided.

Since, on the bottom wall 20d of the movable flange 20, the AE sensor 24 is fixed which detects the elastic wave generated at the grinding work point of the abrasive wheel 14 and outputs the AE signal SAE, the elastic wave from the grinding work point of the abrasive wheel 14 can be detected by attaching the movable flange 20 to the rotating shaft 16 in a state of being contacted with pressure to the side surface of the abrasive wheel 14. Further, at replacement of the abrasive wheel 14, since only the abrasive wheel 14 to which the movable flange 20 is contacted with pressure can be replaced and other parts and be reused, there is no need to replace the AE sensor 24, the preamplifier 26 or the transmission circuit portion 28, whereby size increase of the abrasive wheel 14 or limitation on the applicable grinding work device 12 is suppressed, it can be applied also to the abrasive wheel not having the base metal (wheel core).

Moreover, according to the AE-signal detecting device 10 for the abrasive wheel 14 of this embodiment, the AE sensor 24 has the reception plate 24a which detects the elastic wave on the one end part and is fixed to the outer peripheral wall 20c in a state where the reception plate 24a is directed to the outer peripheral wall 20c. The distance from the grinding work point of the abrasive wheel 14 is made short, and the elastic wave from the grinding work point of the abrasive wheel 14 can be detected further clearly.

Moreover, according to the AE-signal detecting device 10 for the abrasive wheel 14 of this embodiment, in the accommodating space 20f of the movable flange 20, the preamplifier 26 which amplifies the AE signal SAE output from the AE sensor 24 and outputs the amplified AE signal SAE to the transmission circuit portion 28 and the battery 30 which supplies the constant voltage to the transmission circuit portion 28 and the preamplifier 26 are disposed. The elastic wave from the grinding work point of the abrasive wheel 14 can be received by the reception circuit portion 38 with fixed position easily.

### Embodiment 2

Subsequently, another embodiment of the present invention will be described. In the following explanation, the parts in common with other embodiments are given the same signs, and the explanation will be omitted.

An AE-signal detecting device 110 for the abrasive wheel 14 of this embodiment is, as shown in FIG. 17, different from the AE-signal detecting device 10 for the abrasive wheel 14 in the embodiment 1 in a point that the AE sensor 24 is fixed to the bottom wall 20d of the movable flange 20, but the other parts are constituted similarly.

The AE sensor 24 is fixed to the bottom wall 20d by an adhesive 20h in a state fitted in a fitting hole 20g formed in the bottom wall 20d of the movable flange 20.

The inventors conducted an experiment for verifying a difference between the case where the AE sensor 24 is provided in the base metal and the case in which the AE sensor 24 is provided on the bottom wall 20d of the movable flange 20 sandwiching the vitrified CBN grinding stone not having the base metal as shown in FIG. 17 with a common point that the vitrified CBN grinding stone was used under the grinding condition described below.

<Grinding Condition>

Grinding stone: CB 80 N 200 V

Grinding machine: General-purpose cylindrical grinding machine

Grinding method: Wet plunge grinding

Grinding-stone peripheral speed: 1500 m/min

Workpiece material: SCM435 hardened steel HRc48±2

Workpiece peripheral speed: 0.45 m/sec

Cutting speed: R0.8 mm/min

Grinding fluid: Noritake Cool SEC700 (×50)

Grinding-fluid flowrate: 20 L/min

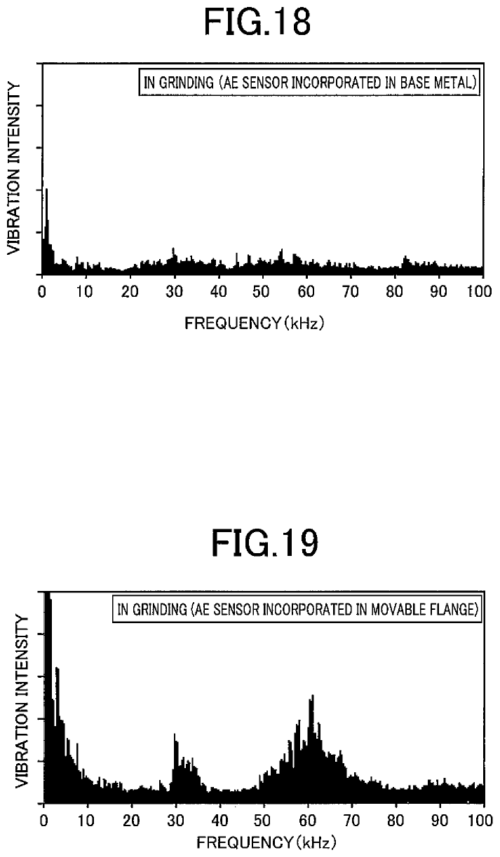

FIG. 18 illustrates a frequency spectrum of the AE signal obtained when the AE sensor 24 incorporated in the base metal of the CBN vitrified grinding stone was used with the cutting speed at R0.8 mm/min and the peripheral speed at 1500 m/min, and FIG. 19 illustrates a frequency spectrum of the AE signal obtained when the AE sensor 24 fixed to the bottom wall of the movable flange 20 sandwiching the CBN vitrified grinding stone was used under the similar grinding condition. In the frequency spectrum shown in FIG. 19, a waveform is clearer as compared with that in FIG. 18, and the intensity (amplitude) also appeared larger.

As described above, according to the AE-signal detecting device 110 for the abrasive wheel 14 of this embodiment, in addition to the effect of the aforementioned embodiment, the movable flange 20 has the annular outer peripheral wall 20c, the bottom wall 20d closing the one end of the outer peripheral wall 20c and brought into close contact with the abrasive wheel 14, and the accommodating space 20f open to the side opposite to the abrasive wheel 14 formed, and the AE sensor 24 is fixed to the bottom wall 20d in the accommodating space 20f and detects the elastic wave transmitted from the abrasive wheel 14 through the movable flange 20. As a result, the elastic wave generated at the grinding work point of the abrasive wheel 14 can be detected further clearly.

### Embodiment 3

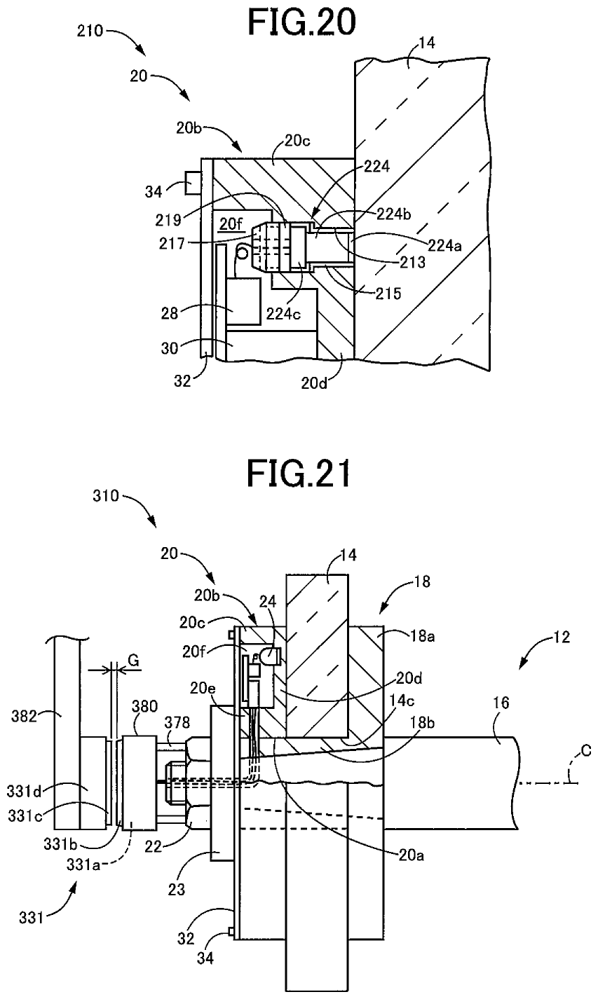

An AE-signal detecting device 210 for the abrasive wheel 14 of this embodiment is, as shown in FIG. 20, different from the AE-signal detecting device 10 for the abrasive wheel 14 of the embodiment 1 in a point that an AE sensor 224 is fixed in a state penetrating the bottom wall 20d of the movable flange 20, while the other parts are constituted similarly.

In FIG. 20, in the movable flange 20 of the AE-signal detecting device 210 for the abrasive wheel 14, a through hole 213 is formed by penetrating the bottom wall 20d in a direction parallel to the rotation center line C, and the AE sensor 224 is disposed such that the AE sensor 224 passes through the through hole 213 and a reception plate 224a at a distal end surface of the AE sensor 224 is in contact with the side surface of the abrasive wheel 14. The AE sensor 224 has a columnar distal end portion 224b and a large-diameter portion 224c with a diameter larger than that of the distal end portion 224b, while the through hole 213 has a stepped hole shape in which the columnar distal end portion 224b and the large-diameter portion 224c of the AE sensor 224 are fitted in through a vibration insulation sheet 215 having elasticity so that removal of the AE sensor 224 is prevented.

A bolt 217 is screwed with an opening portion on an inner side of the through hole 213, and the bolt 217 biases the AE sensor 224 through an elastic material 219 such as rubber. In a state before attachment of the movable flange 20, the reception plate 224a at the distal end surface of the AE sensor 224 slightly protrudes from the through hole 213 to the abrasive wheel 14 side, and when the movable flange 20 is brought into close contact with the abrasive wheel 14, the AE sensor 224 is fixed to the bottom wall 20d in a state where the reception plate 224a is in direct close contact with the abrasive wheel 14.

As described above, according to the AE-signal detecting device 210 for the abrasive wheel 14 of this embodiment, in addition to the effect of the aforementioned embodiment, since the AE sensor 224 has the reception plate 224a, and the AE sensor 224 is fixed to the bottom wall 20d such that the reception plate 224a directly close contacts with the abrasive wheel 14, the elastic wave from the grinding work point of the abrasive wheel 14 can be detected further clearly.

### Embodiment 4

An AE-signal detecting device 310 for the abrasive wheel 14 of this embodiment is, as shown in FIG. 21, constituted similarly to the AE-signal detecting device 10 for the abrasive wheel 14 of the embodiment 1 except that a non-contact power-feeding device 331 is provided instead of the battery 30.

In FIG. 21, the battery 30 is not provided in the accommodating space 20f of the movable flange 20, and an outer case 380 supported through a plurality of (four in this embodiment) support shafts 378 is provided on a side opposite to the nut 22 with respect to the abrasive wheel 14 where the nut 22 is located with respect to the abrasive wheel 14 on the side opposite to the fixed flange. Regarding a radial dimension, the outer case 380 has a diameter sufficiently smaller than the fixed flange 18 and the movable flange 20 and has an outer diameter smaller than a smallest diameter of the annular accommodating space 20f in the aforementioned embodiment, that is, diameter of the outer peripheral surface of the inner peripheral wall 20e of the movable flange 20 and has an outer diameter equal to that of the nut 22.

In the outer case 380, a constant-voltage power-supply circuit portion 331a and a power-receiving coil 331b are provided. At a distal end portion of a fixed arm 382 provided with fixed position, a coil driving circuit 331d and a power-feed coil 331c are fixed. The power-receiving coil 331b and the power-feed coil 331c are provided at the outer case 380 and the distal end portion of the fixed arm 382, respectively, and magnetically coupled with a slight gap G in the rotation center line C direction and relatively rotatively around the rotation center line C. The constant-voltage power-supply circuit portion 331a converts power supplied to the power-receiving coil 331b to a constant-voltage power and supplies it to the preamplifier 26, the transmission circuit portion 28 and the like. The constant-voltage power-supply circuit portion 331a, the power-receiving coil 331b, the coil driving circuit 331d, and the power-feed coil 331c function as the non-contact power-feeding device 331 of this embodiment.

As described above, according to the AE-signal detecting device 310 for the abrasive wheel 14 of this embodiment, in addition to the effect of the aforementioned embodiment, the constant-voltage power-supply circuit portion 331a receives power supply through the non-contact power-feeding device 331 including the power-feed coil 331c with fixed position and the power-receiving coil 331b rotated with the rotating shaft 16, which are magnetically coupled with each other. In addition to the effect of the aforementioned embodiment, maintenance such as voltage check, replacement or the like of the battery 30 is not necessary, and deviation of the center of gravity by uneven distribution of the battery 30 with a relatively large weight is solved.

### Embodiment 5

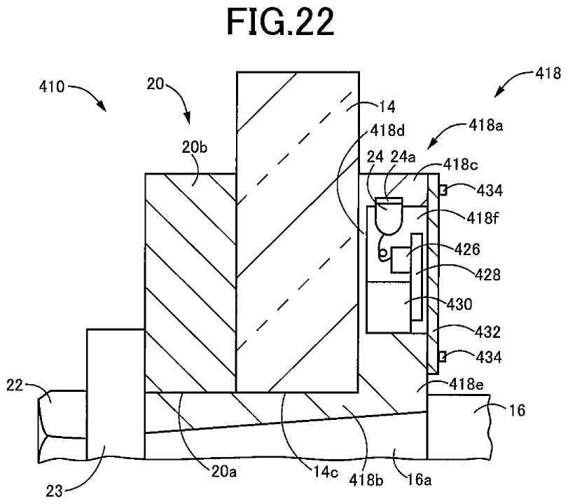

A detecting portion of an AE-signal detecting device 410 for the abrasive wheel 14 of this embodiment is different from the embodiment 1 in a point that it is provided not in the movable flange 20 but in a fixed flange 418 fitted in the rotating shaft 16 by a tapered shape of the fixed flange, as shown in FIG. 22.

The fixed flange 418 is made of iron, similarly to the fixed flange 18, and the abrasive wheel 14 is attached in a state clamped between the fixed flange 418 and the movable flange 20. The fixed flange 418 has a cylinder portion 418b which has a tapered surface and fitted to the tapered portion 16a formed on the shaft end part of the rotating shaft 16 and a fixed flange portion 418a, which is a disc part protruding in the radial direction from one end of the cylinder portion 418b.

The fixed flange portion 418a integrally has a cylindrical outer peripheral wall 418c, a bottom wall 418d closing one end of the outer peripheral wall 418c and brought into close contact with the abrasive wheel 14, and a cylindrical inner peripheral wall 418e concentrical with the outer peripheral wall 418c, and an annular accommodating space 418f open to aside opposite to the abrasive wheel 14 is formed therein. The AE sensor 24 is fixed to the inner peripheral surface of the outer peripheral wall 418c in the accommodating space 418f and detects the elastic wave transmitted from the grinding point of the abrasive wheel 14 to the outer peripheral wall 418c.

In the accommodating space 418f, a preamplifier 426 which amplifies an output signal of the AE sensor 24, a transmission circuit portion 428 constituted by a circuit board including an antenna and a transmission circuit and transmitting an output signal from the preamplifier 426 to the air, and a battery 430 which supplies a constant voltage to the transmission circuit portion 428 which AD-converts the output signal from the preamplifier 426 and transmits it to the air are fixedly provided.

The battery 430 is a secondary battery which functions as a constant-voltage power-supply circuit portion and supplies power to the preamplifier 426 and the transmission circuit portion 428. A lid plate 432 is constituted by a material transmitting a radio wave, that is, a non-conductive material such as a synthetic resin plate, a glass plate or the like, for example, and is fixed to the fixed flange 418 by a lock screw 434 in a state closing the opening of the accommodating space 418f.

According to the detection portion of the AE-signal detecting device 410 of this embodiment, similarly to the AE-signal detecting device 10 of the embodiment 1, the AE-signal detecting device 410 includes the fixed flange 418 having the cylindrical outer peripheral wall 418c, the bottom wall 418d closing one end of the outer peripheral wall 418c and brought into close contact with the abrasive wheel 14, and the accommodating space 418f open to the side opposite to the abrasive wheel 14, the AE sensor 24 which is fixed to the outer peripheral wall 418c in the accommodating space 418f, detects the elastic wave generated at the grinding work point of the abrasive wheel 14, and outputs the AE signal SAE, the transmission circuit portion 428 which is provided in the accommodating space 418f and wirelessly transmits the AE signal SAE output from the AE sensor 24, and the non-conductive lid plate 432 which closes the opening of the accommodating space 418f.

Since the AE sensor 24 which detects the elastic wave generated at the grinding work point of the abrasive wheel 14 and outputs the AE signal SAE is fixed on the bottom wall 418d of the fixed flange 418, the elastic wave from the grinding work point of the abrasive wheel 14 can be detected by attaching the fixed flange 418 to the rotating shaft 16 in the state of being pressure-welded to the side surface of the abrasive wheel 14. Moreover, at replacement of the abrasive wheel 14, since only the abrasive wheel 14 to which the fixed flange 418 is contacted with pressure can be replaced and reused, there is no need to replace the AE sensor 24, the preamplifier 426 or the transmission circuit portion 428, whereby size increase of the abrasive wheel 14 or limitation on the applicable grinding work device 12 is suppressed, and it can be applied also to the abrasive wheel not having the base metal (wheel core).

The embodiment of the present invention has been described by using the figures, but the present invention is applied to the other modes.

For example, in FIG. 2 and FIG. 3 of the aforementioned embodiment, instead of the movable flange 20, a disc-shaped pressing plate pressed by the nut 22 through the washer 23 and a thick and disc-shaped spacer interposed between the pressing plate and the abrasive wheel 14 may be provided. In this case, in the spacer, the AE sensor 24, the preamplifier 26, the transmission circuit portion 28, and the battery 30 are provided similarly to the movable flange 20. The spacer is provided move toward and away from the fixed flange 18 and functions as the aforementioned movable flange 20 which fastens and fixes the abrasive wheel 14 between the movable flange 20 and the fixed flange 18.

Note that the aforementioned is only one embodiment of the present invention, and the present invention can be changed in various ways within the range not departing from the gist thereof.

### REFERENCE SIGNS LIST

10, 110, 210, 310, 410 AE-signal detecting device

14 Abrasive wheel

14a Abrasive grain

14b Binding material

16 Rotating shaft

18, 418 Fixed flange

20 Movable flange

20c, 418c Outer peripheral wall

20d, 418d Bottom wall

20f, 418f Accommodating space

24, 224 AE sensor

24a, 224a Reception plate

28, 428 Transmission circuit portion

30, 430 Battery (constant-voltage power-supply circuit portion)

331 Non-contact power-feeding device

331a Constant-voltage power-supply circuit portion

331b Power-receiving coil

331c Power-feed coil

32, 432 Lid plate

38 Reception circuit portion

1. An AE-signal detecting device for an abrasive wheel, comprising:
an AE sensor which outputs an AE signal upon receipt of an elastic wave generated in an annular abrasive wheel sandwiched between a fixed flange fixed to a rotating shaft and a movable flange provided configured to move toward and away from the fixed flange;
a transmission circuit portion which wirelessly transmits the AE signal output from the AE sensor; and
a reception circuit portion which receives the AE signal transmitted wirelessly, wherein
the AE sensor is disposed on the movable flange or the fixed flange, detects the elastic wave transmitted from the abrasive wheel, and outputs the AE signal.

2. The AE-signal detecting device for an abrasive wheel according to claim 1, wherein
the movable flange or the fixed flange has, an accommodating space which includes an annular outer peripheral wall and a bottom wall closing one end of the outer peripheral wall and brought into close contact with the abrasive wheel and is open to a side opposite to the abrasive wheel
and
the AE sensor is fixed to an inner peripheral surface of the outer peripheral wall in the accommodating space and detects the elastic wave transmitted from the abrasive wheel to the outer peripheral wall.

3. The AE-signal detecting device for an abrasive wheel according to claim 1, wherein
in the movable flange or the fixed flange, an accommodating space which includes an annular outer peripheral wall and a bottom wall closing one end of the outer peripheral wall and brought into close contact with the abrasive wheel and is open to a side opposite to the abrasive wheel is formed; and
the AE sensor is fixed to the bottom wall in the accommodating space and detects the elastic wave transmitted from the abrasive wheel.

4. The AE-signal detecting device for an abrasive wheel according to claim 3, wherein
the AE sensor has a reception plate, and the reception plate is fixed to the bottom wall in a state of direct close contact with the abrasive wheel.

5. The AE-signal detecting device for an abrasive wheel according to claim 2, further comprising
a constant-voltage power-supply circuit portion which supplies a constant voltage to the transmission circuit portion, wherein
the transmission circuit portion and the constant-voltage power-supply circuit portion are provided in the accommodating space.

6. The AE-signal detecting device for an abrasive wheel according to claim 2, further comprising
a constant-voltage power-supply circuit portion which supplies a constant voltage to the transmission circuit portion, wherein
the constant-voltage power-supply circuit portion receives power supply through a non-contact power feeding device including a power-feed coil with fixed position and a power-receiving coil rotating with the rotating shaft, which are magnetically coupled with each other.

7. The AE-signal detecting device for an abrasive wheel according to claim 5, wherein
an opening of the accommodating space is closed by a lid plate constituted at least partially by a non-conductive material.

8. The AE-signal detecting device for an abrasive wheel according to claim 1, wherein
the abrasive wheel contains abrasive grains and a binding material which binds the abrasive grains and is integrally molded annularly.
